(19) United States
(12) Patent Application Publication
(10) Pub. No.: US 2009/0081344 A1
(43) Pub. Date: Mar. 26, 2009

(54) Extracting method of residual pesticides and extraction kit

(75) Inventors: Masahiko Kitayama, Bloomington, IN (US); Masaki Kozono, Ibaraki (JP); Takashi Ohmori, Ibaraki (JP)

Correspondence Address: BIRCH STEWART KOLASCH & BIRCH, PO BOX 747, FALLS CHURCH, VA, 22040-0747, US

(73) Assignee: Nippon Meat Packers, Inc., Osaka (JP)

(21) Appl. No.: 11/919,134

(22) PCT Filed: Apr. 24, 2006
(86) PCT No.: PCT/JP2006/309067

§ 371 Date: Apr. 24, 2008

(30) Foreign Application Priority Data
Apr. 25, 2005 (JP) 2005-127206

(51) Int. Cl. A23L 1/015; B01J 20/10; B01J 20/26; B01J 20/04

(52) U.S. Cl. 426/417; 502/412; 502/405; 502/402; 502/400

(57) ABSTRACT

A method of extracting residual pesticides from livestock meat fat and a kit to be used therefor. Namely, a method of extracting residual pesticides comprising; (1) a step of homogenizing livestock meat fat, which is a solidified state, in the presence of water and then separating the fat, (2) a step of treating the thus treated fat with a dehydrating agent, and (3) a step of dissolving the dehydrated fat in a solvent in which fat is soluble, re-dissolving the pesticides in a hydrophilic solvent and then concentrating the solution of the hydrophilic solvent to give a liquid sample for measuring the residual pesticides. A kit to be used in the above-described method. Use of the above method and kit makes it possible to simplify the procedure while achieving an effect of reducing the amount of impurities (an organic acid, etc) extracted.

### TECHNICAL FIELD

The present invention relates to an extracting method of residual pesticides and an extraction kit. More particularly, it relates to a method of extracting residual pesticides in livestock meat fat easily and efficiently, and an extraction kit used therefor.

### BACKGROUND ART

Hitherto, various pesticides have been used for enhancing the productivity of agricultural products. Recently, an international concern is mounting about residual substance in food, and importance of measurement of residual substance in food is recognized. In Japan, the government is attempting to set standards about residual chemicals in food (agricultural products, livestock, etc.) (for example, Notice of Food Safety Division of Pharmaceutical and Food Bureau of Ministry of Welfare and Labor (Japan) in Food Safety Notice No. 0124001, Appendix “Testing methods of pesticides, food additives and veterinary drugs remaining in food,” and partly revising law of Food Sanitation Law, law No. 55 in 2003, published on May 30, 2003).

However, conventional extracting methods were intended to measure few residual substances and were not suited to measure various residual substances. Since various agents are used as pesticides, a method for measuring multiple pesticides at the same time is demanded in order to measure them easily and quickly.

In particular, in measurement of residual pesticides in livestock meat fat, the conventional extracting method was complicated in the extracting steps, and took much time (about 8 hours), cost and labor (about 40 steps), therefore a simple method and a simple kit have been desired. More specifically, after extracting the fat and separating pesticides from the fat, in order to remove contaminants from the separated pesticides, it is necessary to use GPC or other expensive apparatuses and a solid phase extraction column. Accordingly, the operation efficiency was very poor.

Thus, in the conventional measuring method of residual pesticides, the process was very long and complicated until the residual pesticides were extracted from the livestock meat fat, and it was time-consuming and involved many problems.

The inventors investigated for a simple method of extracting residual pesticides, and found that residual pesticides can be extracted easily and efficiently.

More specifically, it is noticed that animal fat is solidified at low temperature and floats in water because it is low in specific gravity. That is, cold water is added to fatty tissues and the fat is solidified, more particularly the fatty tissues are homogenized in iced water and centrifuged, and then the fat solidified in the upper part of centrifuge tube is collected. By the method, contaminants in the fat can be extremely reduced.

The fat obtained above is hardly dissolved in a fat-soluble solvent, since the fat contains much water. Therefore, in order to reduce water in the fat, the fat is treated with a dehydrating agent and then dissolved in the fat-soluble solvent. Next the fat-soluble solvent solution is mixed with a hydrophilic solvent so as to transfer pesticides in the fat-soluble solvent solution to the hydrophilic solvent. The resultant hydrophilic solvent solution is concentrated and dried, and a residue is dissolved in a mixed solvent of hydrophobic solvent and hydrophilic solvent. By the method, a test solution for measurement of residual pesticides can be prepared easily and at low level of contaminants.

The invention is based on this finding, and presents a method of extracting residual pesticides easily and efficiently from livestock meat fat, and an extraction kit used therefor.

### DISCLOSURE OF THE INVENTION

To solve the problems, the invention presents an extracting method of residual pesticides in livestock meat fat comprising the following steps.

(1) A step of separating the fat after homogenizing the livestock meat fat solidified in the presence of added water;

(2) A step of treating the separated fat with a dehydrating agent; and

(3) A step of dissolving the dehydrated fat in a fat-soluble solvent, transferring the pesticides to a hydrophilic solvent, and concentrating the hydrophilic solvent solution, thereby obtaining a test solution for measurement of residual pesticides.

The dehydrating agent is preferably one or two or more types selected from diatom earth, molecular sieve, silica gel, sodium sulfate anhydride, magnesium sulfate anhydride and a high water-absorbing resin, and diatom earth is particularly preferred.

At the step of (3), after concentrating and drying the hydrophilic solvent solution, it is preferable to re-dissolve a residue in a solvent and the solution is treated with a solid phase adsorbent. The solid phase adsorbent may be one or two or more types selected from a magnesium silicate adsorbent, an ion exchanger, silica gel, aluminum oxide and a reversed-phase column carrier, and the magnesium silicate adsorbent is particularly preferred.

The kit of the invention is used in the extracting method mentioned above, and is an extraction kit for residual pesticides in livestock meat fat comprising at least a dehydrating agent and a solid phase adsorbent. The dehydrating agent is preferably one or two or more types selected from diatom earth, molecular sieve, silica gel, sodium sulfate anhydride, magnesium sulfate anhydride and a high water-absorbing resin, and the solid phase adsorbent is preferably one or two or more types selected from a magnesium silicate adsorbent, an ion exchanger, silica gel, aluminum oxide and a reversed-phase column carrier.

### BEST MODE FOR CARRYING OUT THE INVENTION

The method of the invention is an extracting method of residual pesticides comprising the steps mentioned above.

In the method of the invention, first of all, the livestock meat fat sample is put in water and homogenized while the fat is solidified. Since the animal fat is solidified at low temperature, when homogenized in this state, contaminants in the sample can be transferred to a water phase without giving any effect to the fat and the contaminants in the fat can be reduced.

Specifically, to the livestock meat fat sample, cold water is added by 0.5 to 3 parts by weight, preferably 0.8 to 2.0 parts by weight, more preferably about 2.0 parts by weight, and it is homogenized in iced water. The temperature is not limited to an iced water condition and may be in a range of about 0 to 15° C. as far as the solidified state of fat can be maintained.

The homogenizing time is not particularly specified, but it is usually about 1 to 5 minutes, preferably about 2 to 3 minutes.

After being homogenized, the sample is centrifuged and allowed to stand for a while, and the fat solidified on the edge of the centrifuge tube is collected while draining water of the fat.

The collected fat is sent to a next hydrolyzing step. In the method of the invention, the fat is dissolved in a fat-soluble solvent in the next step. When the fat contains much water, the fat cannot be dissolved in the solvent and the pesticides cannot be extracted efficiently. Accordingly, the fat is dehydrated beforehand to lower the water content.

The dehydrating agent includes all ordinary dehydrating agents such as diatom earth, molecular sieve, silica gel, sodium sulfate anhydride, magnesium sulfate anhydride and a high water-absorbing resin, and diatom earth is particularly preferred. Two or more of these dehydrating agents may be used.

The amount of the dehydrating agent to be used may be properly adjusted depending on the water content of the fat or dehydrating capacity of the dehydrating agent, and is usually about 0.5 to 3 times (by weight) of the fat, preferably about 1 to 1.5 times (by weight).

The dehydrated fat is then dissolved in a fat-soluble solvent.

The fat-soluble solvent in the specification refers to a solvent capable of dissolving the fat, and the fat-soluble solvent may be any solvent capable of dissolving the fat, and in the method of the invention, since the pesticides in the fat-soluble solvent solution are transferred to a hydrophilic solvent in a subsequent process, the fat-soluble solvent is preferred to be separated in layer from the hydrophilic solvent. Such fat-soluble solvent includes, for example, n-hexane, cyclohexane and butyl stearate.

The amount of fat-soluble solvent to be used is not particularly specified as far as the fat is dissolved in the solvent, and usually is about 10 to 100 ml per 1 g of fat, preferably about 20 to 50 ml, more preferably about 30 to 40 ml.

The fat may be dissolved in the fat-soluble solvent also in the presence of the dehydrating agent.

The fat-soluble solvent solution containing the fat is then mixed with a hydrophilic solvent, and the pesticides in the solution are transferred to the hydrophilic solvent.

The hydrophilic solvent used in this process is preferably a solvent capable of being separated in layer from the fat-soluble solvent, and when n-hexane is used as fat-soluble solvent, for example, acetonitrile, methanol and dimethyl sulfoxide (DMSO) may be used. When cyclohexane or butyl stearate is used as fat-soluble solvent, for example, acetonitrile, methanol and DMSO may be used as hydrophilic solvent.

The amount of the hydrophilic solvent to be used is not particularly specified as far as the pesticides can be transferred from the fat-soluble solvent solution, but usually the amount is about equivalent to that of the fat-soluble solvent.

The hydrophilic solvent solution which contains the pesticides is then concentrated, and, if necessary, dried, and dissolved again in a proper solvent. Thus a test solution for measurement of residual pesticides is prepared.

The solvent for re-dissolving is not particularly specified as far as the pesticides can be dissolved and no adverse effect is given to analytical apparatus of pesticides, but generally a mixed solvent of hydrophobic solvent and hydrophilic solvent is used. In consideration of toxicity, boiling point, melting point and price of the solvent, a mixed solvent of n-hexane and acetone is used preferably. The mixing ratio of the hydrophobic solvent and hydrophilic solvent is not particularly specified, but usually a mixed solvent of equivalent amounts is used.

After the re-dissolving step, the residual pesticides are analyzed and determined by known analysis apparatus and means such as GC/MS.

The hydrophilic solvent solution which contains pesticides or the solution re-dissolving the residue prepared by concentrating and drying said hydrophilic solvent solution is preferably treated with a solid phase adsorbent to reduce contaminants.

The solid phase adsorbent is, for example, a magnesium silicate adsorbent (for example, Florisil, Florisil containing active carbon), an ion exchanger, silica gel, aluminum oxide and a reversed-phase column carrier, which may be selected depending on the polarity of contaminants. Two or more solid phase adsorbents may be used together.

The amount of the solid phase adsorbent to be used may be properly adjusted depending on the amount of contaminants contained in the solution, and is usually about 10 to 50 (w/v) % of the solution, preferably about 20 to 35 (w/v) %.

By this operation, the content of contaminants such as pigment in the solution is extremely reduced, and it contributes to simplification of pretreatment of sample in machine analysis and reduction of noise during measurement.

The solid phase adsorbent and the solution can be separated by conventional methods of filtration, centrifugation and the like.

According to the method of the invention, organic acid and other contaminants can be removed easily, and noise-free measurement data can be obtained without spending much time (extraction+measurement time is reduced from about 9 hours to 2 hours), cost and labor (about 40 steps are reduced to about 23 steps). Thus, in measurement of residual pesticides in livestock meat fat, noise-free data can be obtained easily and promptly as compared with the conventional method.

The method and the kit of the invention may be applied not only in extraction of residual pesticides in livestock meat fat, but also in extraction of residual pesticides in solid dairy products of butter, cheese and the like.

The extraction kit for residual pesticides in livestock meat fat of the invention is a kit used for the extracting method of the invention, and includes at least the dehydrating agent and the solid phase adsorbent.

The dehydrating agent and the solid phase adsorbent may be selected from the examples mentioned before.

The kit of the invention may also include other elements such as the fat-soluble solvent, the hydrophilic solvent and a solvent for measurement of residual pesticides.

The solvent for measurement of residual pesticides is preferably a mixed solvent of hydrophobic solvent and hydrophilic solvent, and a mixed solvent of n-hexane and acetone is more preferable.

The kit of the invention may be used according to the extracting method of the invention.

The livestock meat fat to be measured in the invention is not particularly specified as far as measurement of residual pesticides is necessary, and examples include pork, beef, chicken, mutton, and rabbit meat.

The pesticides to be extracted are not particularly specified as far as used in the agricultural field. The invention is preferably applied for measurement of fat-soluble pesticides in particular.

### INDUSTRIAL APPLICABILITY

According to the method of the invention, the livestock meat fat is homogenized in water while the fat is solidified, and contaminants can be removed from the sample without giving any effect to the fat, and the test solution for measurement of residual pesticides can be prepared without requiring complicated process such as column purification. Therefore, according to the method of the invention, the extraction is extremely simplified.

The kit of the invention is used in the method, and the method can be executed easily by using the kit.

### EXAMPLES

The invention is more specifically described below by referring to Comparative Example and Examples, but the invention is not limited to these Examples alone. In Examples, the numeral in parentheses refers to the step number.

### Comparative Example 1

### Conventional Method

From ham of pork (lump), 200 g of fatty portion was sampled (1), and ground by a meat grinder (2). 20 g was weighed and dispensed in a homogenizer cup (3), 20 ml of water was added (4), and homogenized for 3 minutes at 10,000 rpm (5). A mixed solution of acetone and n-hexane (1:2) was added by 100 ml (6), and homogenized again for 3 minutes at 10,000 rpm (6). The homogenate was transferred to a centrifuge tube (7), and centrifuged for 5 minutes at 2,500 rpm (8). The supernatant was poured into a separating funnel (9), and the residue was transferred to a homogenizer cup (10), and 50 ml of n-hexane was added (11), and the content was homogenized for 3 minutes at 10,000 rpm (12). The homogenate was transferred to a centrifuge tube (13), and centrifuged for 5 minutes at 2,500 rpm (14). The supernatant was transferred to the same separating funnel containing the supernatant (15), and 50 g of sodium sulfate anhydride was added (16), and the solution was shaken and dehydrated for 5 minutes (17). The solution was filtered, and the filtrate was transferred to a 300 ml eggplant-shape flask (18). The solution was concentrated in vacuo at 35° C. (19). Concentration in vacuo was stopped immediately before caking, and a dry and solid fat was obtained under nitrogen stream (20). The fat was weighed by 1 g (21), and dissolved in a mixed solution of acetone and cyclohexane (1:4) (22), and 10 ml of the solution was measured and obtained as an extract liquid (23). The extract liquid was transferred to a centrifuge tube (24), and centrifuged for 5 minutes at 3,000 rpm (25), and 5 ml of the obtained supernatant was subjected to a GPC column (27) stabilized by a mixed solution of acetone and cyclohexane (1:4) (26), and eluted by using a mixed solution of acetone and cyclohexane (1:4) (28). A fraction containing pesticides was sampled (29), and the sampled eluate was concentrated in vacuo at 35° C. (30). Concentration in vacuo was stopped immediately before caking, and it was dried and caked under nitrogen stream (31), and the residue was dissolved in 2 ml of a mixed solution of acetone and n-hexane (1:1) (32). The solution was subjected to a PSA solid phase extraction column (3 ml, 500 mg) (34), conditioned with a mixed solution of acetone and n-hexane (1:1) (33), and 18 ml of a mixed solution of acetone and n-hexane (1:1) was applied, and the eluate was collected (35). The collected eluate was concentrated in vacuo at 35° C. (36), and concentration in vacuo was stopped immediately before caking, and it was dried and caked under nitrogen stream (37). The residue was dissolved in 1 ml of a mixed solution of acetone and n-hexane (1:1) (38), and it was transferred to a sample vial (39), and presented for GC/MS analysis (40).

### Example 1

### Method of the Invention

From ham of pork (lump), 200 g of fatty portion was sampled (1), and ground by a meat grinder (2). 20 g was weighed and dispensed in a homogenizer cup (3), 30 ml of cold water was added (4), and homogenized for 3 minutes at 10,000 rpm (5). The homogenate was transferred to a centrifuge tube (6), and was centrifuged for 10 minutes at 4° C. and 5,000×g (7). The fat solidified in the upper part of the centrifuge tube was collected at the edge of the centrifuge tube while draining water (8). One g of the fat was sampled (9), and 1 g of diatom earth was added (10), and 40 ml of n-hexane was added to dissolve the fat (11), and the solution was transferred to a separating funnel (12). After adding 40 ml of acetonitrile (13), the solution was shaken for 15 minutes (14), and the acetonitrile layer was collected (15), and was concentrated and dried in vacuo at 35° C. (16). The residue was dissolved in 1 ml of a mixed solution of n-hexane and acetone (4:1) (17), and transferred to a 1.5 ml Eppendorf tube (18), and 0.3 g of Florisil was added (19) and stirred (20). The solution was centrifuged for 5 minutes at 4° C. at 10,000 rpm (21). The supernatant was transferred to a sample vial (22), and presented for GC/MS analysis (23).

The number of steps and required time (extraction+measurement) of the conventional method and the method of the invention are compared as follows.

| | | |
|---|---|---|
| Conventional method | 40 steps | 540 minutes |
| Method of the invention | 23 steps | 120 minutes |

### Example 2

In the conventional method and the method of the invention, recovery tests were conducted by adding 0.2 μg of each pesticide to 1 g of fat. Test results (recovery rate: %) are shown in Table 1. Among the pesticides mentioned in the table, investigation in imported meat is obligatory in three pesticides, that is, p,p-DDT, Dieldrin and Heptachlor.

As clear from the results in Table 1, the method of the invention recorded higher recovery rates, and the method of the invention is proved to extract various residual pesticides efficiently.

TABLE 1
Recovery rate by addition of equivalent amount of
0.2 μg of pesticide to 1 g of fat.
Fat-soluble pesticides

| | Conventional | Method of the |
|---|---|---|
| Pesticide | method | invention |
| p,p-DDT | 71.3 | 82.7 |
| Dieldrin | 76.1 | 81.7 |
| Heptachlor | 73.2 | 83.3 |
| Isoprocarb | 73.1 | 83.8 |
| Fenobucarb | 76.5 | 80.3 |
| Ethoprophos | 75.4 | 80.7 |
| Chloropropham | 76.7 | 88.2 |
| Bendiocarb | 75.3 | 78.7 |
| a-BHC | 73.1 | 77.8 |
| Terbufos | 68.8 | 71.1 |
| r-BHC | 76.7 | 88.0 |
| Diazinon | 68.5 | 70.8 |
| Etrimfos | 78.7 | 80.1 |
| Tefluthrin | 74.3 | 78.7 |
| Pirimicarb | 76.7 | 79.7 |
| b-BHC | 87.4 | 88.7 |
| Benfuresate | 83.4 | 87.7 |
| d-BHC | 85.3 | 88.2 |
| Tolclophos-methyl | 74.3 | 78.1 |
| Methyl parathion | 83.1 | 87.3 |
| Carbaryl | 72.7 | 80.2 |
| p.p-DDE | 72.3 | 81.8 |
| Flusilazole | 65.4 | 72.8 |
| Myclobutanil | 69.8 | 71.9 |
| Cyproconazole | 73.2 | 77.8 |
| Chlorbenzilate | 78.8 | 83.7 |
| Fensulfothion | 68.8 | 73.3 |
| p,p-DDD | 78.8 | 88.3 |
| Mepronil | 76.6 | 79.4 |
| Edifenphos | 70.5 | 71.8 |
| Propiconazole 1 | 70.1 | 70.2 |
| Propiconazole 2 | 87.1 | 87.3 |
| Lenacil | 68.4 | 70.2 |
| Thenylchlor | 81.2 | 83.4 |
| Tebuconazole | 84.3 | 87.7 |
| EPN | 65.4 | 70.8 |
| Iprodione | 67.4 | 78.8 |
| Tebufenpyrad | 68.7 | 71.3 |
| Pyriproxyfen | 67.5 | 77.2 |
| Cyhalothrin | 72.3 | 81.7 |
| Phosalone | 62.3 | 72.9 |
| Mefenacet | 80.3 | 87.8 |
| Acrinathrin | 76.5 | 81.1 |
| Fenarimol | 75.4 | 78.2 |
| Pirimiphos-methyl | 70.6 | 71.8 |
| Esprocarb | 70.2 | 80.3 |
| Fenitrothion | 83.3 | 87.7 |
| Malathion | 80.2 | 82.3 |
| Metolachlor | 65.4 | 71.1 |
| Thiobencarb | 66.6 | 70.7 |
| Chlorpyrifos | 68.8 | 72.8 |
| Fenthion | 71.2 | 73.8 |
| Dimethylvinphos | 80.1 | 83.1 |
| Diethofencarb | 79.9 | 87.3 |
| Isofenphos-oxon | 67.2 | 88.1 |
| Parathion | 80.3 | 83.8 |
| Dicofol (DEG) | 70.5 | 83.7 |
| Fosthiazate | 68.8 | 71.8 |
| Chlorfenvinphos | 67.8 | 88.1 |
| Aldrin | 69.7 | 80.3 |
| Isofenphos | 74.5 | 88.9 |
| Pendimethalin | 78.7 | 81.7 |
| Pyrifenox Z | 70.2 | 70.4 |
| Phenthoate | 76.5 | 83.8 |
| Quinalphos | 74.3 | 81.1 |
| Pyrifenox E | 71.2 | 73.1 |
| Pretilachlor | 68.9 | 71.3 |
| Flutolanil | 72.1 | 77.1 |
| Pyraclofos | 68.9 | 72.7 |
| Permethrin | 58.8 | 70.7 |
| Pyridaben | 67.5 | 71.7 |
| Cyfluthrin | 78.6 | 81.3 |
| Cypermethrin | 77.5 | 81.0 |
| Flucythrinate | 74.5 | 78.7 |
| Fenvalerate | 78.3 | 81.0 |
| Fluvalinate | 73.3 | 77.9 |
| Deltamethrin | 73.2 | 78.2 |
| Endrin | 76.5 | 80.8 |
| Methiocarb | 68.8 | 70.1 |
| Cadusafos | 66.5 | 71.2 |
| Triadimenol | 78.4 | 80.8 |
| Paclobutrazol | 78.9 | 81.1 |
| o,p-DDT | 75.4 | 80.7 |
| Heptachloroepoxide B | 77.6 | 80.1 |
| Heptachloroepoxide A | 78.9 | 82.3 |
| Endosulfan β | 78.5 | 82.3 |
| Endosulfan α | 76.4 | 81.1 |

1. An extracting method of residual pesticides in livestock meat fat comprising the following steps:
(1) a step of separating the fat after homogenizing the livestock meat fat solidified in the presence of added water;
(2) a step of treating the separated fat with a dehydrating agent; and
(3) a step of dissolving the dehydrated fat in a fat-soluble solvent, transferring the pesticides to a hydrophilic solvent, and concentrating the hydrophilic solvent solution, thereby obtaining a test solution for measurement of residual pesticides.

2. The extracting method of claim 1, wherein the dehydrating agent is one or two or more types selected from diatom earth, molecular sieve, silica gel, sodium sulfate anhydride, magnesium sulfate anhydride and a high water-absorbing resin.

3. The extracting method of claim 1 or 2, wherein the step (3) includes steps of concentrating and drying the hydrophilic solvent solution, dissolving again in a solvent, and treating the solution with a solid phase adsorbent.

4. The extracting method of claim 3, wherein the solid phase adsorbent is one or two or more types selected from a magnesium silicate adsorbent, an ion exchanger, silica gel, aluminum oxide and a reversed-phase column carrier.

5. The extracting method of claim 4, wherein the magnesium silicate adsorbent is Florisil or Florisil containing active carbon.

6. An extraction kit for residual pesticides in livestock meat fat comprising at least a dehydrating agent and a solid phase adsorbent.

7. The extraction kit of claim 6, wherein the dehydrating agent is one or two or more types selected from diatom earth, molecular sieve, silica gel, sodium sulfate anhydride, magnesium sulfate anhydride and a high water-absorbing resin.

8. The extraction kit of claim 6 or 7, wherein the solid phase adsorbent is one or two or more types selected from a magnesium silicate adsorbent, an ion exchanger, silica gel, aluminum oxide and a reversed-phase column carrier.
